(19) United States
(12) Patent Application Publication
(10) Pub. No.: US 2008/0152982 A1
(43) Pub. Date: Jun. 26, 2008

(54) SOLID OXIDE FUEL CELL POWER GENERATOR

(75) Inventors: Michio HORIUCHI, Nagano (JP); Shigeaki Suganuma, Nagano (JP); Jun Yoshiike, Nagano (JP); Fumimasa Katagiri, Nagano (JP); Yasue Tokutake, Nagano (JP)

Correspondence Address: DRINKER BIDDLE & REATH (DC), 1500 K STREET, N.W., SUITE 1100, WASHINGTON, DC, 20005-1209, US

(73) Assignee: Shinko Electric Industries Co., Ltd., Nagano (JP)

(21) Appl. No.: 11/963,355

(22) Filed: Dec. 21, 2007

(30) Foreign Application Priority Data
Dec. 25, 2006 (JP) 2006-348087

(51) Int. Cl. H01M 8/10

(52) U.S. Cl. 429/30

(57) ABSTRACT

A solid oxide fuel cell power generator according to the invention includes a plurality of solid oxide fuel cells C having a cathode electrode layer 2 and an anode electrode layer 3 formed on both sides of a solid electrolytic substrate 1, the solid oxide fuel cell C is interposed between a first electric conductor 1 having gas permeability and disposed in contact with the cathode electrode layer 2 and a second electric conductor 42 having gas permeability and disposed in contact with the anode electrode layer 3 where the first electric conductor 41 and the second electric conductor 42 are assembled with an insulator 5, and the first electric conductor 41 and the second electric conductor 42 are functioning as collectors.

### BACKGROUND OF THE INVENTION

1. Field of the Invention

The present invention relates to a solid oxide fuel cell power generator, and more particularly to a solid oxide fuel cell power generator having a structure in which a solid oxide fuel cell including a solid electrolytic substrate having a cathode electrode layer and an anode electrode layer formed thereon is provided and a closure is not required.

2. Description of the Related Art

In recent years, various fuel cells of a power generating type have been developed, including a solid oxide fuel cell where a solid electrolyte is employed. As an example of the solid oxide fuel cell, a burned product constituted by stabilized zirconia having yttria (Y₂O₃) added thereto is used as a solid electrolytic layer of an oxygen ion conducting type. A cathode electrode layer is formed on one of surfaces of the solid electrolytic layer while an anode electrode layer is formed on an opposite surface thereto, and oxygen or an oxygen containing gas is supplied to the cathode electrode layer side, and furthermore, a fuel gas such as methane is supplied to the anode electrode layer.

In the solid oxide fuel cell, oxygen (O₂) supplied to the cathode electrode layer is changed into an oxygen ion (O²⁻) at a boundary between the cathode electrode layer and the solid electrolytic layer, and said oxygen ion is conducted to the anode electrode layer through the solid electrolytic layer. Further, said oxygen ion reacts to a fuel gas, such as methane (CH₄) gas, which is supplied to the anode electrode layer, resulting in that water (H₂O), carbon dioxide (CO₂), hydrogen (H₂) and carbon monoxide (CO) are generated. In the reaction, the oxygen ion discharges an electron. Therefore, an electric potential difference is made between the cathode electrode layer and the anode electrode layer. If a lead wire is connected between the cathode electrode layer and the anode electrode layer, the electron in the anode electrode layer flows into the cathode electrode layer through the lead wire, by which electric power is generated as the solid oxide fuel cell. A driving temperature of the solid oxide fuel cell is approximately 1000° C.

The power generator using the solid oxide fuel cell of this type, however, requires different separate chambers, namely an oxygen or oxygen containing gas supplying chamber, and a fuel gas supplying chamber, which are respectively provided on the cathode electrode layer side and the anode electrode layer side separately from each other. In addition, it is inevitable for those chambers to be exposed to an oxidizing atmosphere and a reducing atmosphere at a high temperature. For these reasons, it is said that such a power generator is difficult to improve its durability of the solid oxide fuel cell.

On the other hand, a solid oxide fuel cell having the following type has been developed. That is, a cathode electrode layer and an anode electrode layer are provided on opposite surfaces of a solid electrolytic layer in the solid oxide fuel cell, and the fuel cell is put in a fuel gas, for example, a mixed fuel gas mixing a methane gas and an oxygen gas to generate an electromotive force between the cathode electrode layer and the anode electrode layer. In the solid oxide fuel cell of this type, the principle mechanism for generating the electromotive force between the cathode electrode layer and the anode electrode layer is the same as that of the solid oxide fuel cell of the separating type chamber as already explained above. However, since the whole solid oxide fuel cell can be set into a substantially identical atmosphere, it is possible to obtain a single type chamber in which the mixed fuel gas is supplied. Thus, this type of the fuel cell makes it possible to enhance the durability of the solid oxide fuel cell.

However, as for the power generator using the solid oxide fuel cell of the single type chamber, its driving operation is eventually requires to be carried out at a high temperature of approximately 1000° C. For this reason, there is a risk of an explosion of the mixed fuel gas. In order to avoid such a risk, an oxygen concentration shall be set to be lower than the boundary condition of its explosion. However, in this case, there is a problem in that a fuel, such as methane, is more likely to be carbonized so that a cell performance is deteriorated. Therefore, there has been further proposed a power generator using a solid oxide fuel cell having a single type chamber which can use a mixed fuel gas in an oxygen concentration capable of suppressing the progressive carbonization of the fuel and preventing the explosion of the mixed fuel gas simultaneously as disclosed in JP A 2003-92124 Publication.

In the power generator using the solid oxide fuel cell having the single type chamber, it is not necessary to strictly separate a fuel and air from each other as in a conventional power generator using a solid oxide fuel cell, however, a hermetic sealing structure must be employed. A plurality of plate-shaped solid oxide fuel cells are laminated and connected by using an interconnecting material having a heat resistance and a high electric conductivity to increase an electromotive force in such a manner that a driving operation can be carried out at a high temperature. For this reason, the solid oxide fuel cell power generator having the single type chamber using the plate-shaped solid oxide fuel cell becomes a large-scaled structure, which ends up being a problem of increased cost. Moreover, as for an operation of the solid oxide fuel cell power generator having the single type chamber, a temperature is controlled to gradually rise from a need of preventing a crack of the solid oxide fuel cell. In this regard, the start timing of an electromotive operation is prolonged, which might be practically inefficient.

Therefore, there has been proposed an open type solid oxide fuel cell power generator in which a solid oxide fuel cell does not need to be accommodated in a container having a sealing structure such as disclosed in JP A 2005-353571 Publication or JP A 2005-63692 Publication. In the solid oxide fuel cell power generator, there has been disclosed a configuration in which a flame can be also utilized directly to supply a fuel to the fuel cell. Since an electrostatic generating time can be shortened having a single structure as well, therefore, a size, a weight and a cost of the fuel cell can be reduced advantageously. In respect of the direct utilization of the flame, the fuel cell power generator can be incorporated into a general combustion apparatus or annealing apparatus and it has been expected that the fuel cell power generator is utilized as a power supply apparatus.

The Patent document 2 has proposed a solid oxide fuel cell power generator 10 in which a plurality of plate-shaped solid oxide fuel cells C are arranged at a predetermined interval, where anode electrode layers 3 and cathode electrode layers 2 of the adjacent solid oxide fuel cells Care electrically connected via a metallic mesh 100, resulting in the solid oxide fuel cells C being wholly connected in series as shown in FIGS. 17A and 17B. For the solid oxide fuel cell power generator 10, an integrally large electrode is not used but a technique for combining a plurality of small electrodes is utilized in order to obtain a predetermined electrode area. Thus, a predetermined electrical output characteristic can be obtained, and furthermore, a manufacturing cost can be reduced and its durability and maintenance capability can be enhanced.

In the solid oxide fuel cell power generator 10 according to JP A 2005-353571 Publication, moreover, the metallic mesh 100 is a collecting member for the solid oxide fuel cell C and is embedded in or fixed to the anode electrode layer 3 and the cathode electrode layer 2 so that an electrical bonding state to the respective electrode layers 2 and 2 is formed.

In addition, JP A 2005-63692 Publication has disclosed a solid oxide fuel cell power generator 10 in which a plural sets of plate-shaped solid oxide fuel cells C are disposed in a grid array shape, being connected in parallel and/or in series as shown in FIG. 18. Also in the solid oxide fuel cell power generator 10, an electrode area having a predetermined size is formed by combining a plurality of electrodes in a plurality of sets in the same manner as that of being already discussed with referring to JP-A-2005-353571 Publication.

In the solid oxide fuel cell power generator 10 described in JP A 2005-63692 Publication, the number of the solid oxide fuel cells C can be properly arranged with having wiring being connected in parallel and/or in series, of which design might be varied in accordance with its output characteristic being required.

In the solid oxide fuel cell power generator 10, moreover, each of the solid oxide fuel cells C is supported through a wiring 200 or a reinforcing metal wire.

In the solid oxide fuel cell power generator described in JP-A-2005-353571 Publication, the metallic mesh to be the collector is embedded in or fixed to the electrode layer of the solid oxide fuel cell. The electrode layer of the solid oxide fuel cell is usually formed of ceramics. The electrode layer is manufactured by first printing a paste-like material on a solid electrolytic substrate and then carrying out annealing at a temperature of 1000° C. or more. In this case, a volume is greatly reduced over the paste-like electrode layer after the annealing. On the other hand, the metallic mesh does not have the change in the volume due to the annealing. For this reason, the metallic mesh cannot be embedded in or fixed to the electrode layer simultaneously with the manufacture of the electrode layer. Therefore, it is necessary to carry out the annealing again in order to bury or fix the metallic mesh into the electrode layer subjected to the annealing. Thus, the number of the steps of manufacturing the solid oxide fuel cell power generator is increased.

In the solid oxide fuel cell shown in FIGS. 17A and 17B, moreover, the metallic mesh is embedded in or fixed to each electrode layer, and there is a restriction on a structure that the solid oxide fuel cell cannot be treated individually.

Further, in the case of the metallic mesh being embedded in the electrode layer, annealing is usually carried out at a high temperature of 1000° C. or more. Although it is a matter of a metal that is employed for forming the metallic mesh, an oxidation or a heat deterioration might be caused by such annealing in some cases.

In the solid oxide fuel cell power generator that is disclosed in JP-A-2005-63692 Publication, each of the solid oxide fuel cells is not harnessed strong enough in some cases. Therefore, further improvement in harnessing the solid oxide fuel cell has been desired.

### SUMMARY OF THE INVENTION

Accordingly, it is an object of the invention to provide an open type solid oxide fuel cell power generator of which collector structure is simple and a solid oxide fuel cell can be harnessed reliably.

In order to solve the problems, the invention provides a solid oxide fuel cell power generator comprising: a plurality of solid oxide fuel cells, each including at least a solid electrolytic substrate, a cathode electrode layer formed on one surface of the solid electrolytic substrate, and an anode electrode layer formed on the other surface thereof, and an insulator accommodating said plurality of solid oxide fuel cells, wherein each of said plurality of solid oxide fuel cells is interposed between a first electric conductor having gas permeability and disposed in contact with the cathode electrode layer and a second electric conductor having gas permeability and disposed in contact with the anode electrode layer, further wherein the first electric conductor and the second electric conductor are assembled with an insulator being interposed in-between, and the first electric conductor and the second electric conductor are functioning as collectors.

A third electric conduct or having gas permeability is disposed between the first electric conductor and the cathode electrode layer or between the second electric conductor and the anode electrode layer in at least one of the cathode electrode layer and the anode electrode layer in the solid oxide fuel cell.

Moreover, the first electric conductor, the second electric conductor and the third electric conductor are formed by a metallic mesh or a porous body, and furthermore, the metallic mesh or the porous body which is disposed on the anode electrode layer side of the solid oxide fuel cell is formed of nickel or a nickel alloy.

In addition, the insulator is formed like a frame having a hole portion, and the solid oxide fuel cell is fitted in the hole portion, and furthermore, the hole portions are formed like a grid on the insulator, and the first electric conductor and the second electric conductor cover a whole surface of the insulator, and particularly, a thickness of the insulator is smaller than that of the solid oxide fuel cell.

Moreover, the insulator is formed by an inorganic oxide sintered body, an inorganic oxide sheet having a flexibility or a metal plate having a surface covered with inorganic oxide.

Furthermore, the first electric conductor and the second electric conductor are assembled by conductive harness means in a plurality of portions in the insulator, and the first electric conductor or the second electric conductor and the harness means are electrically insulated from each other.

In addition, there is provided a plurality of fuel cell units in which the solid oxide fuel cell is interposed between the first electric conductor and the second electric conductor, and the first electric conductor and the second electric conductor are assembled to each other by the insulator, the fuel cell units being electrically connected in series.

According to the open type solid oxide fuel cell power generator in accordance with the invention, a fuel cell is harnessed reliably with having a collector in a simple structure.

### BRIEF DESCRIPTION OF THE DRAWINGS

FIG. 1 is a plan view showing a first embodiment of a solid oxide fuel cell power generator according to the invention,

FIG. 2 is an enlarged sectional view taken along an X1-X1 line in FIG. 1,

FIGS. 3A and 3B show a solid oxide fuel cell constituting the solid oxide fuel cell power generator in FIG. 1 and FIG. 3A is its plan view, while FIG. 3B is an enlarged sectional view taken along an X3-X3 line in (a),

FIG. 4 is a plan view showing a first electric conductor layer constituting the solid oxide fuel cell power generator in FIG. 1,

FIG. 5 is a plan view showing an insulator constituting the solid oxide fuel cell power generator in FIG. 1,

FIG. 6 is an enlarged sectional view taken along an X2-X2 line in FIG. 1,

FIG. 7 is a sectional view showing a variant of FIG. 6,

FIG. 8 is a sectional view corresponding to FIG. 2, illustrating a second embodiment of the solid oxide fuel cell power generator according to the invention,

FIG. 9 is a sectional view corresponding to FIG. 2, illustrating a third embodiment of the solid oxide fuel cell power generator according to the invention,

FIG. 10 is a sectional view corresponding to FIG. 2, illustrating a fourth embodiment of the solid oxide fuel cell power generator according to the invention,

FIGS. 11A to 11C show a first electric conductor layer in FIG. 10, where FIG. 11A is a perspective view showing a first electric conductor layer in FIG. 10, FIG. 11B is a partial sectional view of Fig. A, while FIG. 11C is a view showing a variant of FIG. 11B,

FIG. 12 is a sectional view corresponding to FIG. 2, illustrating a fifth embodiment of the solid oxide fuel cell power generator according to the invention,

FIG. 13 is a sectional view corresponding to FIG. 2, illustrating a variant of the fifth embodiment of the solid oxide fuel cell power generator according to the invention,

FIG. 14 is a sectional view corresponding to FIG. 2, illustrating a sixth embodiment of the solid oxide fuel cell power generator according to the invention,

FIGS. 15A and 15B are views showing an inside of a first electric conductor layer to which an upper insulator in the solid oxide fuel cell power generator of FIG. 13 is fixed, where FIG. 15A is a plan view while FIG. 15B is an enlarged sectional view taken along an X4-X4 line in (a),

FIG. 16 is a typical view showing a seventh embodiment of the solid oxide fuel cell power generator according to the invention,

FIGS. 17A and 17B are views showing a fuel cell of a solid oxide fuel cell power generator according to the prior art, where

FIG. 17A is a plan view while FIG. 17B is a top view, and

FIG. 18 is a plan view showing a fuel cell of a solid oxide fuel cell power generator according to another prior art.

### DESCRIPTION OF THE PREFERRED EMBODIMENTS

Embodiments of the present invention will be described hereinbelow by reference to the drawings. Unless otherwise specifically defined in the specification, terms have their ordinary meaning as would be understood by those of ordinary skill in the art.

A solid oxide fuel cell power generator according to the invention will be described below based on a first preferred embodiment with reference to the drawings.

### First Embodiment

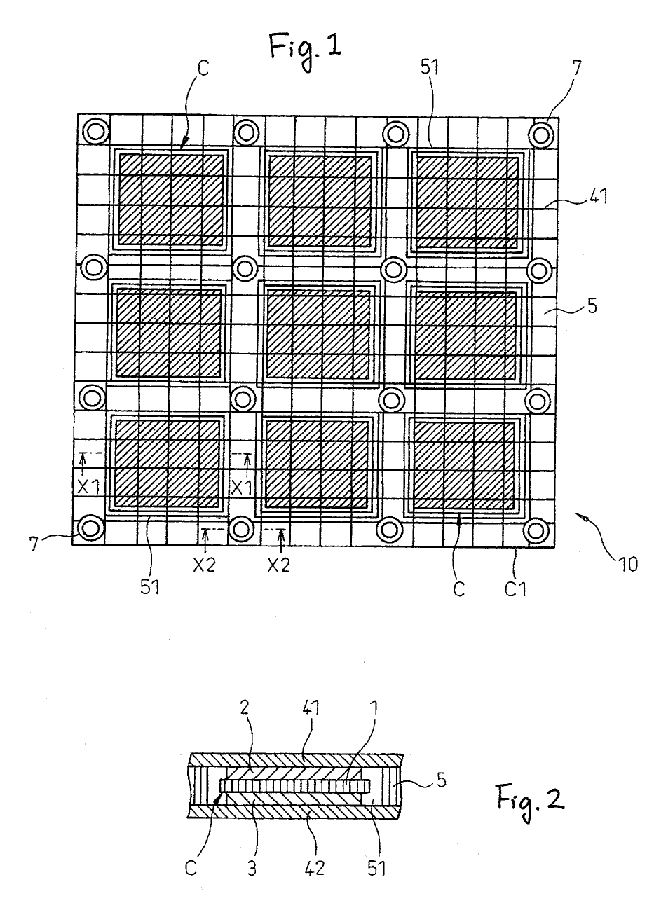

A solid oxide fuel cell power generator 10 according to the embodiment (which will be hereinafter referred to as the SOFC power generator) comprises a plurality of solid oxide fuel cells C, each having a cathode electrode layer 2 and an anode electrode layer 3, being formed on both sides of a solid electrolytic substrate 1 as shown in FIGS. 1 to 6.

In the SOFC power generator 10, moreover, the solid oxide fuel cell C is interposed between a first electric conductor 41 having gas permeability and disposed in contact with the cathode electrode layer 2 and a second electric conductor 42 having gas permeability and disposed in contact with the anode electrode layer 3. The first electric conductor 41 and the second electric conductor 42 are assembled by an insulator 5. The first electric conductor 41 and the second electric conductor 42 form a collector.

The SOFC power generator 10 is a so-called open type solid oxide fuel cell power generator, and the anode electrode layer 3 may be directly exposed to a flame to supply a fuel, thereby generating a power. Alternatively, the solid oxide fuel cell C may be accommodated in a container to supply a mixed fuel gas of a fuel and oxygen into the container, thereby generating a power. Moreover, the SOFC power generator 10 has an apparatus for supplying a mixed fuel gas obtained by premixing a fuel gas and an oxidant gas and a combustion apparatus, which is not shown.

The SOFC power generator 10 will further be described below.

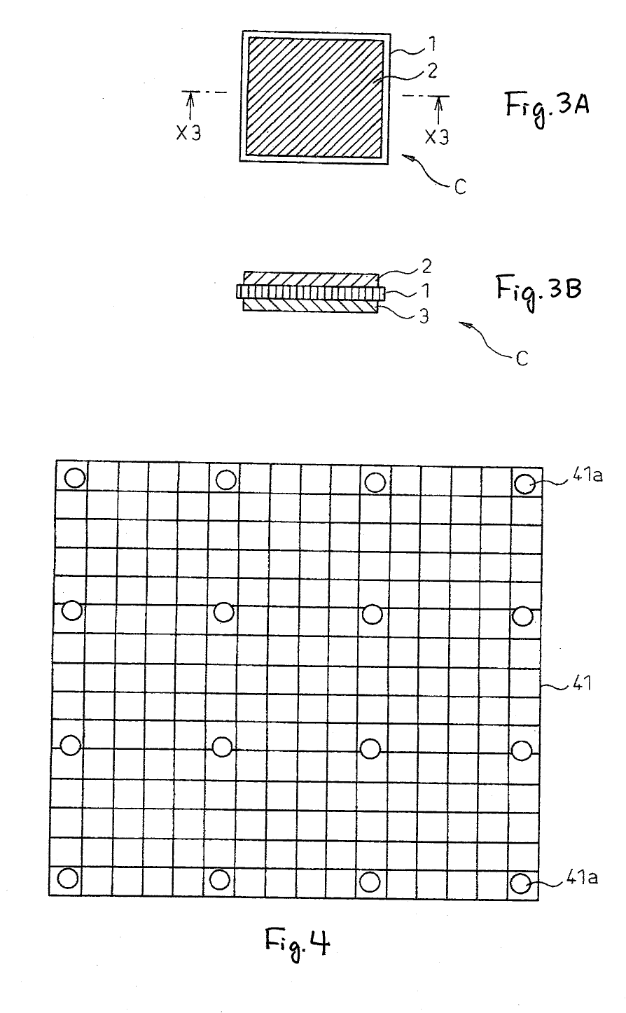

As shown in FIGS. 2, 3A and 3B, the solid oxide fuel cell C has the plate-shaped solid electrolytic substrate 1, and the cathode electrode layer 2 is formed like a plate on one of the surfaces of the substrate 1 and the anode electrode layer 3 is formed like a plate on the other surface thereof. The solid oxide fuel cell C is wholly plate-shaped.

The shape of the solid oxide fuel cell C seen on a plane can be optional depending on uses. In respect of an arrangement of the solid oxide fuel cells C in a predetermined area and a processability, a polygonal shape such as a triangular shape or a square shape is preferable. In the SOFC power generator 10, all of the solid electrolytic substrate 1, the cathode electrode layer 2 and the anode electrode layer 3 take square shapes. Moreover, the cathode electrode layer 2 and the anode electrode layer 3 are formed in equal dimensions and are slightly smaller than the solid electrolytic substrate 1.

The solid oxide fuel cell C is interposed and disposed between the first electric conductor 41 and the second electric conductor 42 which are plate-shaped and have gas permeability as shown in FIG. 2. The whole plane of the plate-shaped cathode electrode layer 2 is provided in physical and electrical contact with the first electric conductor 41 adjacent thereto. Similarly, the whole plane of the plate-shaped anode electrode layer 3 is also provided in physical and electrical contact with the second electric conductor 42 adjacent thereto.

Thus, the first electric conductor 41 and the second electric conductor 42 serve as the collector of the SOFC power generator 10.

In the SOFC power generator 10, the first electric conductor 41 is the same as the second electric conductor 42. Therefore, the first electric conductor 41 will be mainly described. The description is also applied to the second electric conductor 42.

Each of the solid oxide fuel cells C is fitted in each hole portion 51 of the insulator 5 as will be described below in detail. It is preferable that a dimension of the first electric conductor 41 should be greater than the hole portion 51 in which the interposed solid oxide fuel cell C is fitted.

In the SOFC power generator 10, the first electric conductor 41 is formed to be larger than the dimension of the hole portion 51, and more specifically, has a square shape in a plane view which is the same as the shape of the insulator 5 having almost equal dimension thereto.

It is preferable that a material for forming the first electric conductor 41 should have such a rigidity or elasticity such that the solid oxide fuel cell C can be kept being sandwiched in the interposing state. Moreover, it is preferable that the material should have a heat resistance and a durability in a temperature and an atmosphere which are used in the power generation of the solid oxide fuel cell C. Furthermore, it is preferable that the material should have gas permeability so as to enable the supply of the mixed fuel gas to each of the electrode layers 2 and 3. Accordingly, the first electric conductor 41 has gas permeability in at least a perpendicular direction to a planar direction thereof.

From this viewpoint, it is preferable that the first electric conductor 4 should be formed by a metallic mesh, a metal foam, a conductive porous body, a metallic plate taking a corrugated shape, a metallic plate taking a corrugated shape and having a large number of hole portions or a mesh made of carbon graphite.

As shown in FIG. 4, in the SOFC power generator 10, the first electric conductor 41 is formed by the metallic mesh in respect of a cost and a processability.

It is preferable that the mesh in the metallic mesh should have such a size as to enable the fixation of the solid oxide fuel cell C to be interposed and a mesh for covering the anode electrode layer 3 side should have such a size as to cause carbon hydride, hydrogen, a radical or a mixed fuel gas contained in a flame to easily pass therethrough. Similarly, it is preferable that a mesh for covering the cathode electrode layer 2 side should have such a size as to cause an oxygen molecule in gas to easily pass therethrough.

More specifically, it is preferable that a metal wire constituting the mesh in the metallic mesh should have a diameter of 30 to 100 μm and the number of meshes should be 60 to 500. In particular, it is preferable that the wire diameter should be 50 to 150 μm and the number of the meshes should be 70 to 130 in respect of the maintenance, collecting efficiency and processability of the solid oxide fuel cell C.

As a material for forming the metallic mesh, moreover, nickel, a nickel alloy, stainless steel or a heat-resistant and corrosion-resistant alloy is preferable. For the stainless steel, SUS310 or SUS430 is preferable.

In the case in which a carbon hydride fuel having a C—H bond is used as the fuel, particularly, it is preferable that the metallic mesh disposed on the anode electrode layer. 3 side of the solid oxide fuel cell C should be formed by the nickel or the nickel alloy in order to act as a catalyst for cutting the C—H bond of a fuel molecule. In the case in which the metallic mesh is formed by the nickel alloy, particularly, it is preferable that the alloy should be formed of nickel and copper in respect of the non-promotion of the generation of a soot due to the nickel.

In the case in which the metallic mesh is formed by the nickel alloy, it is preferable that a ratio of the nickel to the alloy should be equal to or higher than 60% by mass and be lower than 100% by mass, and particularly, should be equal to or higher than 80% by mass and be lower than 100% by mass in order to sufficiently exhibit the catalytic action. Moreover, it is preferable that the nickel in the alloy should be present on a surface thereof. The description is also applied to the conductive porous body or the metallic plate.

The first electric conductor 41 and the second electric conductor 42 are assembled to the insulator 5 in a separating state from the plate-shaped insulator 5 as shown in FIGS. 1 and 2. The insulator 5 is formed to take a shape of a flame having a plurality of hole portions 51 as shown in FIG. 5.

The insulator 5 will further be described. The hole portions 51 are formed like a grid on the insulator 5 as shown in FIG. 1. In the hole portion 51, the solid oxide fuel cell C is fitted with the cathode electrode layer 2 side turned toward one of plane sides of the insulator 5 and the anode electrode layer 3 side turned toward the other plane side of the insulator 5.

It is preferable that the hole portion 51 should have the same shape as the solid oxide fuel cell C to be fitted therein. In the SOFC power generator 10, the hole portion 51 is formed to take a square shape in the same manner as the solid oxide fuel cell C.

Moreover, it is preferable that a clearance should be formed between the solid oxide fuel cell C and the hole portion 51 with the solid oxide fuel cell C fitted in the hole portion 51 in respect of a processability. In order to increase the area of the solid oxide fuel cell C, it is preferable that a size of the clearance should be as small as possible.

A whole surface of the insulator 5 is covered with the first electric conductor 41 and the second electric conductor 42 as shown in FIGS. 1 and 2. In order to reliably hold the solid oxide fuel cell C fitted in the hole portion 51, it is preferable that a thickness of the insulator 5 should be equal to or smaller than that of the solid oxide fuel cell C. In the SOFC power generator 10, the thickness of the insulator 5 is set to be equal to that of the solid oxide fuel cell C.

In the SOFC power generator 10, thus, the solid oxide fuel cell C is interposed between the first electric conductor 41 and the second electric conductor 42 so that a motion in a perpendicular direction to a planar direction is controlled, and the solid oxide fuel cell C is fitted in the hole portion 51 so that a motion in the planar direction is also controlled. Moreover, the solid oxide fuel cells C are electrically connected in parallel because both of the electrode layers 2 and 3 are provided in contact with both of the electric conductors 41 and 42.

Although the first electric conductor 41 and the second electric conductor 42 have equal dimensions to the dimension of the insulator 5 in FIG. 1, moreover, it is also possible to form an extended portion which is extended form the insulator 5 and to set the extended portion as a power extracting portion.

It is preferable that a material for forming the insulator 5 should have such a strength as to enable the hold of a state in which the solid oxide fuel cell C is fitted. Moreover, it is preferable that the material should have an electrical insulating property, a heat resistance and a durability in a temperature and an atmosphere which are used in the power generation of the solid oxide fuel cell C. From this viewpoint, it is preferable that the insulator 5 should be formed by an inorganic oxide sintered body, an inorganic oxide sheet having a flexibility or a metal plate having a surface covered with inorganic oxide.

Description will further be given. As the inorganic oxide sintered body, ceramics is preferred, for example. More specifically, alumina based ceramics, mullite based ceramics, cordierite based ceramics and forsrite based ceramics are preferable.

It is preferable that the inorganic oxide sheet having the flexibility should be a cloth or a nonwoven fabric which is formed of a fiber made of quartz, glass or alumina based ceramics, for example. It is preferable that the insulator 5 should be formed by the inorganic oxide sheet having the flexibility in order to enhance a shock resistance.

Moreover, examples of the metal plate having a surface covered with inorganic oxide include a metal plate obtained by spraying the ceramics to cover a surface of a metal plate having a plurality of hole portions like a grid. Moreover, it is also possible to employ a metal plate having a surface covered with the inorganic oxide sheet.

In the case in which the metal plate having the surface covered with the inorganic oxide is used as the insulator 5, thus, the shape of the insulator 5 is maintained even if a crack is generated on the covering inorganic oxide during the use because the metal plate is provided as a core member. Therefore, it is possible to continuously hold the solid oxide fuel cell C. In the start-up of the SOFC power generator 10, moreover, the metal plate has a higher thermal conductivity than the solid oxide fuel cell C formed by the ceramics. For this reason, the insulator 5 is first heated up and the heat can be transferred from the insulator 5 thus heated up to the solid oxide fuel cell C fitted in each of the hole portions 51. Consequently, it is possible to shorten a start-up time of the SOFC power generator 10.

In the SOFC power generator 10, a fuel cell unit C1 has the solid oxide fuel cell C interposed between the first electric conductor 41 and the second electric conductor 42, and the first electric conductor 41 and the second electric conductor 42 are assembled with the insulator 5 and are thus formed as shown in FIGS. 1 and 2.

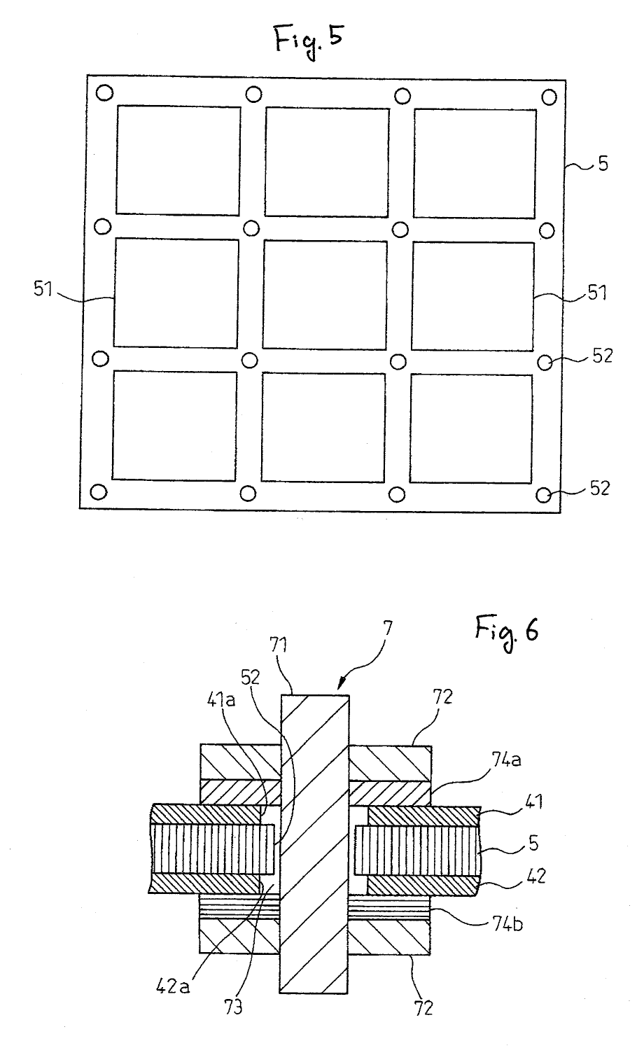

In the fuel cell unit C1, the first electric conductor 41 and the second electric conductor 42 are assembled by conductive harness means 7 in a plurality of portions of the insulator 5 as shown in FIG. 6. In the SOFC power generator 10, the harness means 7 is constituted by a bolt 71 and a nut 72. The bolt 71 is fixed to a bolt hole 73 penetrating in a vertical direction of the fuel cell unit C1. The bolt hole 73 is formed by an overlap of a bolt hole 52 of the insulator 5, a bolt hole 41a of the first electric conductor 41 and a bolt hole 42a of the second electric conductor 42.

In the fuel cell unit C1, the first electric conductor 41 and the second electric conductor 42 are assembled to the insulator 5 in a plurality of portions by a pair of harness means 7 in order to interpose two diagonal lines over an extension of the diagonal lines in the solid oxide fuel cell C taking a square shape.

More specifically, each of the harness means 7 fixes the first electric conductor 41 and the second electric conductor 42 in a portion of the insulator 5 which is surrounded by apexes of the square hole portion 51 in an inner part of the fuel cell unit C1 as shown in FIG. 1. Moreover, the harness means 7 fixes the first electric conductor 41 and the second electric conductor 42 in a portion of the insulator 5 in the vicinity of the apex of the hole portion 51 in a peripheral edge part of the fuel cell unit C1.

As shown in FIG. 6, the harness means 7 screws a pair of nuts 72 into both ends of the bolt 71 in a state in which the bolt 71 is inserted into the bolt hole 73, and presses and fixes the first electric conductor 41 and the second electric conductor 42 onto the insulator 5 with the nuts 72.

Moreover, washers 74a and 74b are provided between the first electric conductor 41 and second electric conductor 42 and the nuts 72 respectively so that the fixation of the electric conductor 41 and the second electric conductor 42 to the insulator 5 can be prevented from being loosened.

In the SOFC power generator 10, furthermore, dimensions of the bolt hole 41a of the first electric conductor 41 and the bolt hole 42a of the second electric conductor 42 which constitute the bolt hole 73 are set to be greater than a diameter of the bolt hole 52 of the insulator 5 as shown in FIG. 6. Consequently, the first electric conductor 41 and the second electric conductor 42 do not come in electrical contact with the bolt 71 inserted through the bolt hole 73.

In the SOFC power generator 10, moreover, the washer 74b disposed between the second electric conductor 42 provided adjacently to the anode electrode layer 3 and the nut 72 is formed by an insulator, and the harness means 7 and the second electric conductor 42 are electrically insulated from each other. In other words, since the bolt 71 and the anode electrode layer 3 are insulated from each other, an insulating state of the anode electrode layer 3 and the cathode electrode layer 2 is ensured. On the other hand, the harness means 7 and the cathode electrode layer 2 are provided in electrical contact with each other. Therefore, the harness means 7 can be used as a power extracting portion of the cathode electrode layer 2.

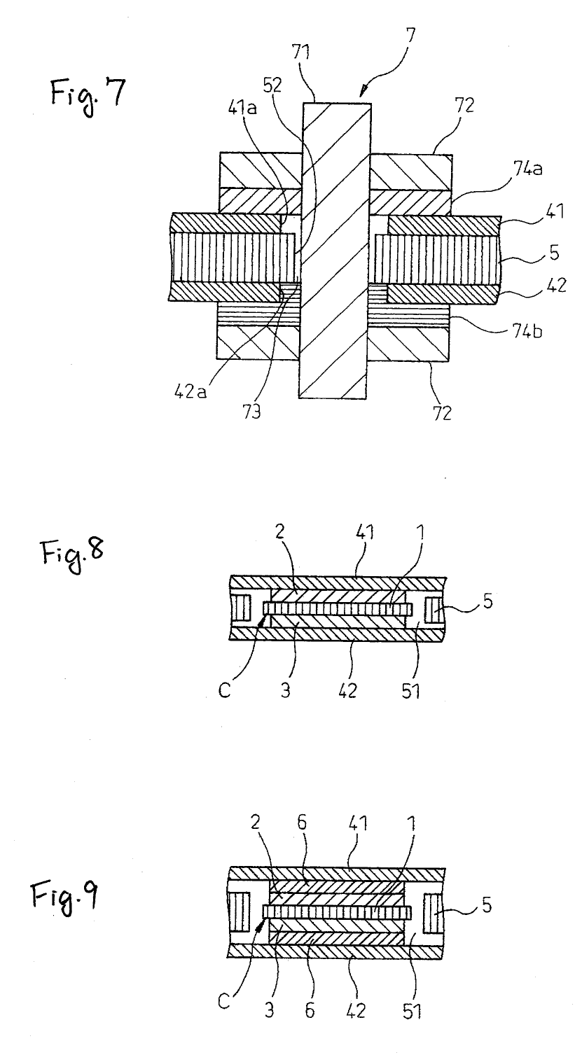

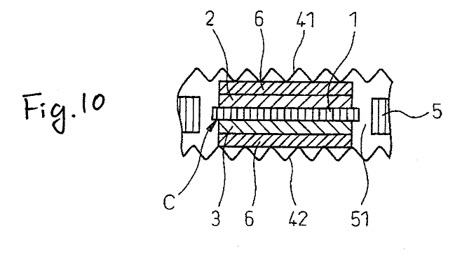

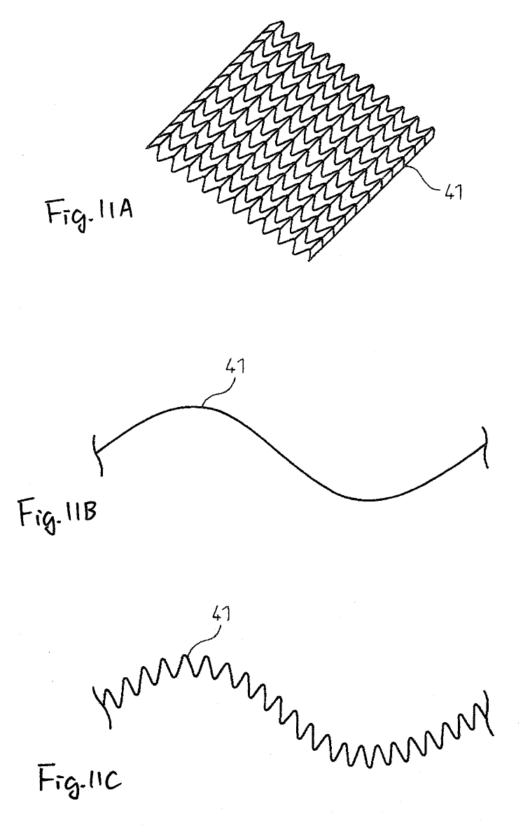

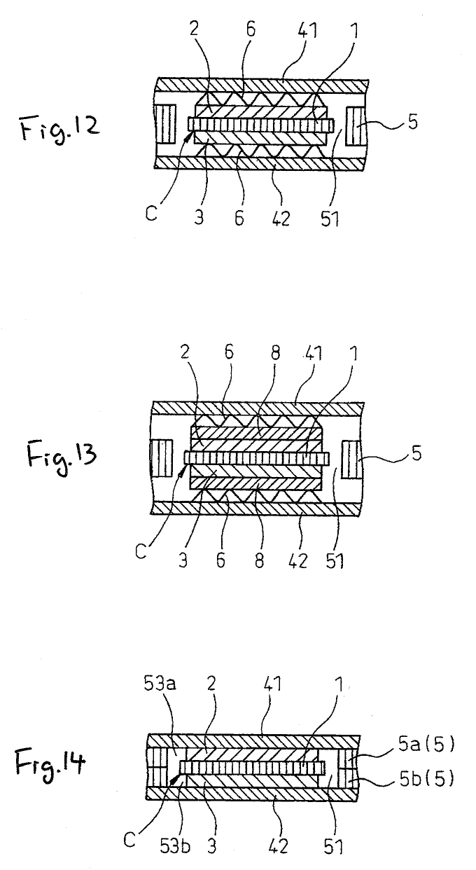

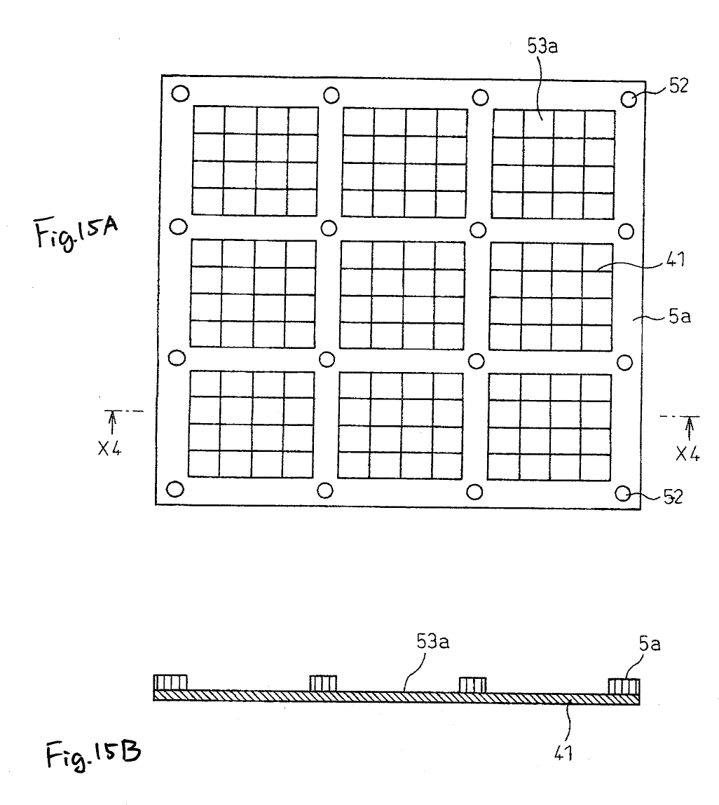

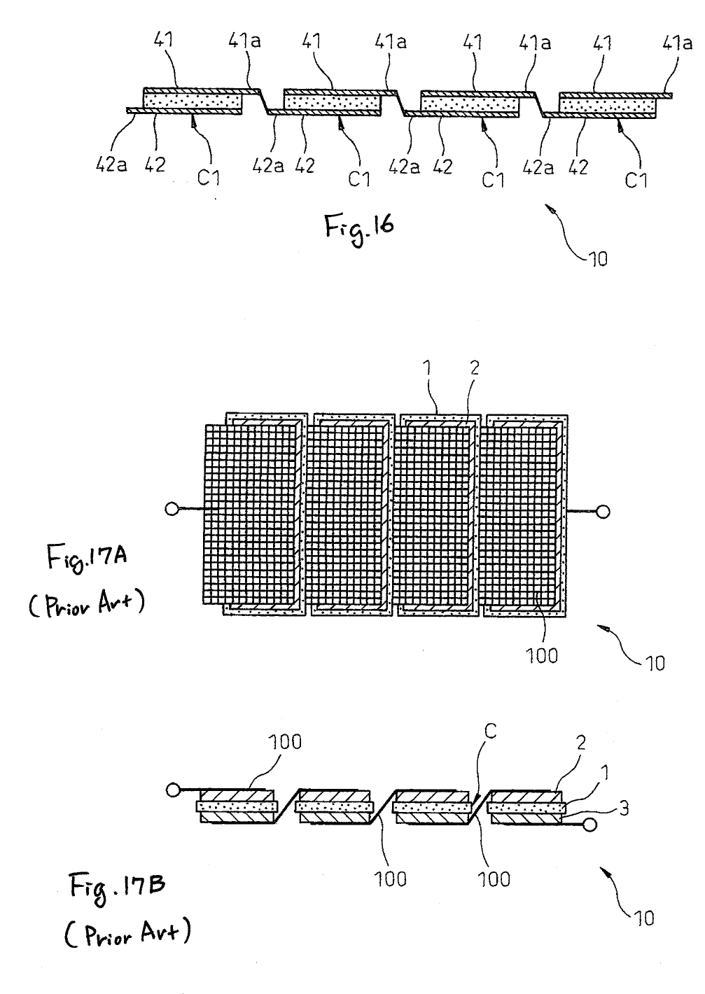

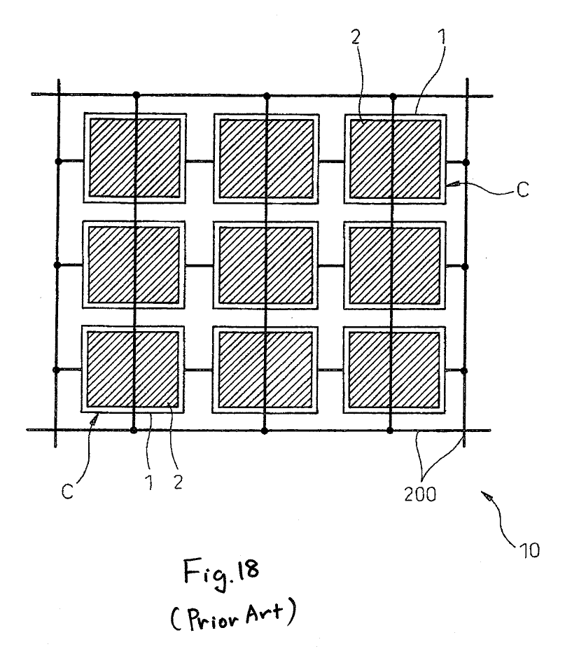

Furthermore, FIG. 7 shows a variant of FIG. 6. In the variant, the insulating washer 74b has a cylindrically vertical portion which is extended vertically toward the insulator 5 side. The vertical portion is fitted in the bolt hole 42a of the second electric conductor 42 which is adjacent to the anode electrode layer 3, and the bolt 71 is inserted through the vertical portion. Thus, an electrical insulation of the harness means 7 and the anode electrode layer 3 is ensured.

In the invention, the dimension of the insulator 5 and the number and dimension of the hole portions 51 formed on the insulator 5 are not particularly restricted but are preferably designed properly depending on uses. In respect of the processability and maintenance of the solid oxide fuel cell C, particularly, it is preferable that a solid oxide fuel cell having a predetermined size should not be manufactured but a plurality of small solid oxide fuel cells should be combined to obtain the large solid oxide fuel cell in the case in which the solid oxide fuel cell having the size is to be manufactured. In other words, it is preferable that a large hole portion should not be provided but three or four hole portions having a dimension of ⅓ or ¼ should be provided. The reason is as follows. The solid oxide fuel cell is formed by using ceramics as a main body. In some cases, therefore, a defect such as a crack or a fracture is generated in the manufacture. The generation of the defect tends to be increased when the dimension of the solid oxide fuel cell is made greater. By the structure, moreover, only the solid oxide fuel cell can be exchanged for a new one if the crack or fracture is generated on the solid oxide fuel cell in the use of the power generator.

In the same respect, a plurality of solid oxide fuel cells C may be fitted in one hole portion 51. Thus, a solid oxide fuel cell having a predetermined size can be formed by a combination of a plurality of small solid oxide fuel cells.

Next, a material for forming the solid oxide fuel cell C will be described below.

A well-known substrate can be employed for the solid electrolytic substrate 1, for example, and the following materials can be used:
a) YSZ (yttria-stabilized zirconia), ScSZ (scandia-stabilized zirconia), and zirconia based ceramics obtained by doping them with Ce or Al;
b) Ceria based ceramics such as SDC (samaria doped ceria) or SGC (gadolia doped ceria); and
c) LSGM (lanthanum gallate), bismuth oxide based ceramics.

In this specification, thus, the solid oxide includes a solid electrolyte.

Moreover, the anode electrode layer 3 is formed by a porous body and a well-known material can be employed for a forming material thereof, for example, and the following materials can be used:
d) cermet of nickel and yttria-stabilized zirconia based, scandia-stabilized zirconia based or ceria based (SDC, GDC or YDC) ceramic;
e) a sintered body containing conductive oxide as a main component (50% by mass or more and 99% by mass or less). The conductive oxide is nickel oxide in which lithium is dissolved, for example; and
f) a substance obtained by blending the substances in the
d) and e) with a metal constituted by a platinum group element or rhenium or oxide thereof in approximately 1 to 10% by mass.

In particular, the materials in the d) and e) are preferable.

The sintered product containing the conductive oxide in the (e) as a main component has an excellent oxidation resistance and can thus prevent a phenomenon, for example, a reduction in an electrical efficiency caused by a rise in an electrode resistance of the anode electrode layer which is generated by an oxidation of the anode electrode layer, a power generating impossibility or a separation of the anode electrode layer from the solid oxide layer. Moreover, nickel oxide having lithium dissolved therein is suitable for the conductive oxide. Furthermore, it is possible to obtain a high power generating performance by blending the materials in the d) and e) with the metal formed of the platinum group element or the rhenium or the oxide thereof.

The cathode electrode layer 2 is formed by a porous body and a well-known material can be employed for the forming material. For example, it is possible to employ manganese to be the third group element in a periodic table such as lanthanum or samarium having strontium (Sr) added thereto (for example, lanthanum strontium manganite), and a gallium or cobalt acid compound (for example, lanthanum strontium cobaltite or samarium strontium cobaltite).

Both the anode electrode layer 3 and the cathode electrode layer 2 are formed by porous bodies, and the solid electrolytic substrate 1 in the SOFC power generator 10 may be formed to be porous. Conventionally, a solid oxide layer is formed to be dense. However, a thermal shock resistance is low and a crack is easily generated by a rapid change in a temperature. In general, the solid oxide layer is formed more thickly than the anode electrode layer and the cathode electrode layer. Therefore, the crack is generated over the whole solid oxide fuel cell to be broken into pieces due to the crack of the solid oxide layer.

Also in the SOFC power generator 10, the individual solid electrolytic substrates are formed to be porous. Therefore, the crack can further be suppressed and the thermal shock resistance can be enhanced more greatly even if they are disposed in a flame or in the vicinity of the flame in the power generation and a change in a temperature is rapidly given, and furthermore, in a heat cycle having a considerable temperature difference. Also in the case in which the solid electrolytic substrate is porous, a remarkable enhancement in the thermal shock resistance is not observed when a porosity is lower than 10%. If the porosity is equal to or higher than 10%, however, an excellent thermal shock resistance is observed. A porosity of 20% or higher is more suitable.

For the solid oxide fuel cell which has been proposed previously, a mesh-like metal or a wire-shaped metal is embedded in the anode electrode layer or the cathode electrode layer or is fixed thereto. This is a countermeasure for carrying out a reinforcement to prevent the solid electrolytic substrate having a crack due to a thermal history from being broken into pieces. According to the countermeasure, also after the solid electrolytic substrate is cracked into pieces, the cracked portions maintain a power generating performance. Therefore, the mesh-like metal or the wire-shaped metal electrically connect the cracked portions and can derive a power as one solid oxide fuel cell.

In the invention, there is employed a structure in which the mesh-like metal or the wire-shaped metal is neither embedded in the anode electrode layer or the cathode electrode layer nor fixed thereto but the solid oxide fuel cell C is interposed between the first electric conductor 41 and the second electric conductor 42 which are disposed in contact with the anode electrode layer 3 and the cathode electrode layer 2, respectively. Even if the solid electrolytic substrate 1 is cracked into pieces, therefore, the cracked portions are held between the first electric conductor 41 and the second electric conductor 42 while maintaining the power generating performance. Therefore, the first electric conductor 41 and the second electric conductor 42 electrically connect the cracked portions and can thus derive a power as the solid oxide fuel cell.

Accordingly, the manufacture of the solid oxide fuel cell C employed in the invention can be more simplified and a manufacturing cost can be reduced more greatly than the process for manufacturing the solid oxide fuel cell proposed previously.

Next, description will be given to an example of the way of assembling the fuel cell unit C1 of the SOFC power generator 10. The second electric conductor 42 is first put on a flat table and the insulator 5 is then superposed on the second electric conductor 42, and the solid oxide fuel cell C is thereafter fitted in each of the hole portions 51 of the insulator 5 with the anode electrode layer 3 turned downward and the first electric conductor 41 is subsequently put on the insulator 5 in which the solid oxide fuel cell C is fitted. Next, the first electric conductor 41 and second electric conductor 42 and the insulator 5 are assembled by using the harness means 7 together with the washers 74a and 74b.

In the fuel cell unit C1 of the SOFC power generator 10, particularly, it is preferable that the anode electrode layer 3 should be directly exposed to a flame to supply a fuel, thereby generating a power. For example, the fuel cell unit C1 is put horizontally and the anode electrode layer 3 is exposed to the flame from below so that the power can be generated. Since the anode electrode layer 3 in the SOFC power generator 10 is formed like a plate, it can be uniformly exposed to the flame. All of the anode electrode layers 3 can be exposed to the flame on the same condition and carbon hydride, hydrogen or a radical (OH, CH, C₂, O₂H, CH₃) present in the flame can easily be utilized as a fuel.

In the case of the plate, moreover, the cathode electrode layer 2 can be blocked from the flame. In a state in which the anode electrode layer 3 is turned toward the flame side, therefore, the cathode electrode layer 2 is exposed to the air. Consequently, the fuel cell unit C1 formed by a plurality of solid oxide fuel cells C can easily utilize oxygen in the air at the cathode electrode layer 2 side in a configuration of an open type so that an oxygen rich state can be maintained. It is also possible to supply a gas containing the oxygen (air or an oxygen rich gas) toward the cathode electrode layer 2 in such a manner that the cathode electrode layer 2 can utilize the oxygen further efficiently.

Moreover, the solid oxide fuel cell C is disposed in the flame or in the vicinity thereof. It is more suitable that the solid oxide fuel cell C should be disposed in a reducing flame in the vicinity of a bottom of the flame. By the disposition in the reducing flame, it is possible to efficiently utilize, as a fuel, carbon hydride, hydrogen or a radical present in the reducing flame. Furthermore, the anode electrode layer which is easily deteriorated by an oxidation can also be used well so that its durability can be maintained.

According to the SOFC power generator 10, the collecting structure of the fuel cell unit C1 is simple and the respective solid oxide fuel cells C can be connected in parallel without using a special wiring. Moreover, the solid oxide fuel cell C can be reliably held by the first electric conductor 41 and the second electric conductor 42 as the collectors. Therefore, the structure can be simplified so that a manufacturing cost can be reduced.

Moreover, the SOFC power generator 10 can properly design the number of the solid oxide fuel cells C depending on the uses. By combining a plurality of small solid oxide fuel cells in order to obtain a solid oxide fuel cell having a predetermined size, moreover, it is possible to enhance the processability and maintenance of the SOFC power generator 10.

Furthermore, the SOFC power generator 10 has the open type structure and does not require a closing structure. Therefore, it is possible to obtain a simple structure.

Next, a solid oxide fuel cell power generator according to another embodiment of the invention will be described below with reference to FIGS. 8 to 16. Referring to respects which are not particularly described for another embodiment, the detailed description related to the embodiment is properly applied to common portions to the first embodiment. Moreover, the same members as those in FIGS. 1 to 7 have the same reference numerals in FIGS. 8 to 16.

### Second Embodiment

A solid oxide fuel cell power generator 10 according to a second preferred embodiment of the invention is shown in FIG. 8. In the SOFC power generator 10, a thickness of an insulator is smaller than that of a solid oxide fuel cell C. Both electrode layers 2 and 3 of the solid oxide fuel cell C have thickness, each being protruded outward in a vertical direction from respective surface of the insulator 5. In the solid oxide fuel cell C, whole surfaces of both the electrode layers 2 and 3 are interposed directly or indirectly between a first electric conductor 41 and a second electric conductor 42. Each solid oxide fuel cell C has two pairs of diagonal lines where a pair of harness means 7 is provided at extended ends of each pair of diagonal line so that the electric conductors 41 and 42 are assembled to the insulator 5 by those harness means 7 as already described above. Therefore, since the electric conductors 41 and 42 are assembled to the insulator 5 in a way such as being stretched over the surface of the solid oxide fuel cell C, it is possible to increase a pressing force to the solid oxide fuel cell C in a planer direction by both of the electric conductors 41 and 42.

It is preferable that the first electric conductor 41 and the second electric conductor 42 should have a predetermined elasticity in order to moderately press and fix the solid oxide fuel cell C in the planar direction.

The other structures are the same as those in the first embodiment.

According to the SOFC power generator 10, a maintenance of the solid oxide fuel cell C is enhanced and an electrical contact state between both of the electrodes 2 and 3 and the first electric conductor 41 and second electric conductor 42 is improved. Therefore, a collecting efficiency can be enhanced.

### Third Embodiment

A solid oxide fuel cell power generator 10 according to a third preferred embodiment of the invention is shown in FIG. 9. In the SOFC power generator 10, a third electric conductor 6 having gas permeability is disposed between a first electric conductor 41 and a cathode electrode layer 2 and between a second electric conductor 42 and an anode electrode layer 3 in the cathode electrode layer 2 and the anode electrode layer 3 of a solid oxide fuel cell C.

The third electric conductor 6 is plate-shaped and a dimension thereof is preferably smaller than that of a hole portion 51. In the SOFC power generator 10, the third electric conductor 6 takes a shape of a square seen on a plane, and has a dimension which is equal to dimensions of both of the electrode layers 2 and 3 in the solid oxide fuel cell C.

In the SOFC power generator 10, a thickness of the solid oxide fuel cell C is equal to that of an insulator 5. However, the third electric conductors 6 are disposed on the outside of the respective electrode layers 2 and 3, and each of them has thickness being protruded outward in a vertical direction from the respective surface of the insulator 5. For the reasons, the solid oxide fuel cell C and a pair of third electric conductors 6 and 6 are reliably harnessed by the first electric conductor 41 and the second electric conductor 42, and furthermore, an electrical contact state of the third electric conductors 6 with the adjacent electrode layers 2 and 3 and both of the electric conductors 41 and 42 can be enhanced.

As a material for forming the third electric conductor 6, the same material as the first electric conductor 41 can be preferably used. Moreover, a metallic wool such as a steel wool may be used. In the SOFC power generator 10, the third electric conductor 6 is formed by a plate-shaped metallic mesh.

In the case in which carbon hydride is used for a fuel, it is preferable that a metallic mesh disposed on the anode electrode layer 3 side of the solid oxide fuel cell C should be formed of nickel or a nickel alloy in order to serve as a catalyst for cutting a C—H bond of a fuel molecule as described above.

The other structures are the same as those in the first embodiment.

According to the SOFC power generator 10, the electrical contact state of both of the electrode layers 2 and 3 and the first electric conductor 41 and second electric conductor 42 in the solid oxide fuel cell C can be enhanced.

### Fourth Embodiment

A solid oxide fuel cell power generator 10 according to a fourth preferred embodiment of the invention is shown in FIG. 10. In the SOFC power generator 10, each of a first electric conductor 41 and a second electric conductor 42 takes a concavo-convex shape. More specifically, the concavo-convex shape can also be set to be a periodic corrugated shape, for example.

The other structures are the same as those in the third embodiment.

In the SOFC power generator 10, each of the first electric conductor 41 and the second electric conductor 42 takes the concavo-convex shape. Therefore, an elasticity and a flexibility in a planar direction and a perpendicular direction to the plane are enhanced and a force for moderately pressing a pair of third electric conductors 6 interposing a solid oxide fuel cell C therebetween in the planar direction is increased so that they are provided in contact with a plane of the third electric conductor 3 in the convex shape. On the other hand, the third electric conductor 6 is plate-shaped and has a large contact area with the electrode layers 2 and 3 so that an electrical contact state with the electrode layers 2 and 3 is excellent.

Each of the first electric conductor 41 and the second electric conductor 42 has a corrugated convex portion formed periodically like a ridge, and a groove-shaped concave portion is formed in parallel with the convex portion between the convex portions as shown in FIGS. 11A and 11B. It is preferable that a length obtained by measuring apexes of the respective convex and concave portions in a perpendicular direction to the planar direction of the electric conductors 41 and 42 should be 0.3 to 0.5 mm in respect of the maintenance of the solid oxide fuel cell C and gas permeability of a mixed fuel gas in a state in which a fuel cell unit C1 is assembled.

As materials for forming the first electric conductor 41 and the second electric conductor 42, the same materials as those in the first embodiment can be preferably used. In the SOFC power generator 10, a metallic mesh is used.

The first electric conductor 41 and the second electric conductor 42 which take the periodic corrugated shape in the SOFC power generator 10 can be obtained by interposing the metallic mesh between a pair of dies having corrugated pressing sections shown in FIGS. 11A and 11B and pressing and molding them, for example.

Each of the electrode layers 2 and 3 in the solid oxide fuel cell C and the plate-shaped third electric conductor 6 are provided in face contact with each other. Therefore, an electron conductivity from the electrode layers to the third electric conductor 6 is sufficiently high. On the other hand, the first electric conductor 41 and the second electric conductor 42 which take the concavo-convex shapes are mainly set into a point contact or line contact state with the third electric conductor 6. Since both of them are formed by the conductors, however, the electron conductivity therebetween can be sufficiently ensured. In the SOFC power generator 10, accordingly, a collecting efficiency from each of the electrode layers 2 and 3 can be increased.

According to the SOFC power generator 10, the maintenance of the solid oxide fuel cell C is improved so that the collecting efficiency can be enhanced.

Moreover, FIG. 11C shows a variant of the fourth embodiment. As in the variant, smaller concavo-convex portions may be formed on the first electric conductor 41. In the variant, a waveform having a shorter cycle than the cycle of a basic waveform is superposed on the corrugated shape shown in FIG. 11B.

In the variant, since the first electric conductor 41 has the small concavo-convex portions, a flexibility thereof is increased. In addition, even if the surface of the third electric conductor 6 is not flat at all, physical and electrical contact points with the third electric conductor 6 are increased. Therefore, the maintenance and colleting efficiency of the solid oxide fuel cell C is further enhanced.

The first electric conductor 41 shown in FIG. 11C can be obtained by interposing the metallic mesh between a pair of dies having corrugated pressing sections in a shorter cycle than that of a pair of dies having the corrugated pressing sections shown in FIGS. 11A and 11B and pressing and molding them, and then pressing and molding them by the pair of dies having the corrugated pressing sections shown in FIGS. 11A and 11B, for example. The whole description related to FIG. 11C is applied to the second electric conductor 42.

Although the first electric conductor 41 or the second electric conductor 42 according to the fourth embodiment has the concavo-convex portions taking the periodic corrugated shape, furthermore, dimple-like concavo-convex portions may be formed regularly or randomly.

### Fifth Embodiment

A solid oxide fuel cell power generator 10 according to a fifth preferred embodiment of the invention is shown in FIG. 12. In the SOFC power generator 10, a pair of third electric conductors 6 has a concavo-convex shape and a first electric conductor 41 and a second electric conductor 42 take a shape of a plate having no corrugated shape differently from FIG. 10.

The concavo-convex shapes of the third electric conductors 6 are periodically corrugated in the same manner as in the first electric conductor 41 or the second electric conductor 42 according to the fourth embodiment. Thus, each of the third electric conductors 6 has the concavo-convex shape. Therefore, an elasticity and a flexibility can be enhanced and a force for moderately pressing a solid oxide fuel cell C in a planar direction is increased in a state in which the third electric conductor 6 is interposed between the first electric conductor 41 and the second electric conductor 42 from an outside.

The other structures are the same as those in the fourth embodiment.

According to the SOFC power generator 10, a maintenance of the solid oxide fuel cell C can be enhanced.

Moreover, FIG. 13 shows a variant of the fifth embodiment. As in the variant, a fourth electric conductor 8 may be disposed between the third electric conductor 6 and the electrode layers 2 and 3. The fourth electric conductor 8 is plate-shaped and takes a square shape seen on a plane, and has a dimension which is equal to dimensions of both of the electrode layers 2 and 3 in the solid oxide fuel cell C.

The fourth electric conductor 8 is pressed and fixed by the first electric conductor 41 or the second electric conductor 42 in a state in which the third electric conductor 6 having the concavo-convex shape is provided therebetween. The solid oxide fuel cell C is interposed between a pair of fourth electric conductors 8.

The respective fourth electric conductors 8 to be plate-shaped have large contact areas between the electrode layers 2 and 3.

As a material for forming the fourth electric conductor 8, the same material as the first electric conductor 41 or the second electric conductor 42 can be used. In the SOFC power generator 10, the fourth electric conductor 8 is formed by a plate-shaped metallic mesh.

According to the variant, a collecting efficiency from each of the electrodes 2 and 3 can be enhanced. In addition, the solid oxide fuel cell C is interposed between the fourth electric conductors 8 so that a maintenance thereof can be further enhanced.

### Sixth Embodiment

A solid oxide fuel cell power generator 10 according to a sixth preferred embodiment of the invention is shown in FIG. 14. In the SOFC power generator 10, an insulator 5 is formed by an upper insulator 5a and a lower insulator 5b. The upper insulator 5a is formed on an inside of a first electric conductor 41 as shown in FIGS. 15A and 15B. Similarly, the lower insulator 5b is formed on an inside of a second electric conductor 42. As shown in FIG. 14, the first electric conductor 41 and the second electric conductor 42 are superposed with insides opposed to each other so that an insulator 5 having the upper insulator 5a and the lower insulator 5b laminated is formed.

An upper hole portion 53a and a lower hole portion 53b are provided like a grid on the upper insulator 5a and the lower insulator 5b. The upper hole portion 53a and the lower hole portion 53b are superposed on each other so that a hole portion 51 is formed.

As described above, in the SOFC power generator 10, the first electric conductor 41 is the same as the second electric conductor 42 and the upper insulator 5a is the same as the lower insulator 5b. The upper insulator 5a will be described below and the description is applied to the lower insulator 5b.

The upper insulator 5a of the SOFC power generator 10 will further be described. The upper insulator 5a has a shape obtained by dividing the insulator 5 into two parts in a vertical direction thereof and is formed like a frame in an inner part of the first electric conductor 41 excluding a part for forming the hole portion 51 as shown in FIGS. 15A and 15B. The upper insulator 5a has a certain thickness.

The upper insulator 5a can be manufactured in the following manner, for example.

First of all, a ceramic paste is applied like the frame to the inside of the first electric conductor 41 in a certain thickness and the first electric conductor 41 to which the ceramic paste is applied is heat treated at a predetermined temperature to cure the ceramic paste so that the first electric conductor 41 having the upper insulator 5a fixed to the inside is obtained as shown in FIGS. 15A and 15B. The temperature of the heat treatment is generally lower than a temperature at which the ceramics are burned. Therefore, a heat deterioration of the first electric conductor 41 can be prevented and a processability of the SOFC power generator 10 can be enhanced.

Examples of the ceramic paste include a water-soluble inorganic adhesive paste containing aluminum oxide, silicon dioxide, magnesium oxide or zirconium oxide as a main component.

The other structures are the same as those in the first embodiment.

According to the SOFC power generator 10, a fuel cell unit C1 can easily be assembled and an excellent processability can be obtained.

### Seventh Embodiment

A solid oxide fuel cell power generator according to a seventh preferred embodiment of the invention is shown in FIG. 16. In the SOFC power generator in this embodiment, a plurality of fuel cell units C1, C1, are electrically connected in series. It is noted that each cell C1 is illustrated as a single cell in FIG. 16, however, said single-like cell represents the cell unit such as already described in FIG. 1 or FIG. 5.

In each of the fuel cell units C1, a first electric conductor 41 and a second electric conductor 42 have extended portions (not shown), each being extended outwardly from certain peripheral portion of the insulator 5 of the cell module C1. They form a power extracting portion 41a of a cathode electrode layer 2 and a power extracting portion 42a of an anode electrode layer, respectively. The power extracting portion 41a of the cathode electrode layer 2 and the power extracting portion 42a of the anode electrode layer are extended in opposite directions to each other. The power extracting portions 41a of the cathode electrode layers and the power extracting portions 42a of the anode electrode layers in the adjacent fuel cell units C1 are coupled to each other through a wiring so that an electrically serial connection is wholly made.

Thus, the fuel cell units C1 are electrically connected in series so that it is possible to increase an electromotive force which can be derived from the SOFC power generator 10. The number of the fuel cell units C1 to be connected in series is properly designed depending on uses.

While the power extracting portions are bonded to each other via the wiring in the SOFC power generator 10, the first electric conductors 41 and the second electric conductors 42 in the adjacent fuel cell units C1 may be formed integrally by a single electric conductor.

The solid oxide fuel cell power generator according to the invention is not restricted to the embodiments but can be variously changed without departing from the scope of the invention.

For example, in the solid oxide fuel cell power generator according to the invention, only the washer 74b on the anode electrode layer 3 side is formed by the insulator in each of the embodiments. However, only the washer 74a on the cathode electrode layer 2 side may be formed by the insulator or both of the washers 74a and 74b may be formed by the insulator.

While the third electric conductor 6 is disposed on the cathode electrode layer 2 and the anode electrode layer 3 of the solid oxide fuel cell C in the third to sixth embodiments, moreover, the third electric conductor 6 may be disposed on at least one of the cathode electrode layer 2 and the anode electrode layer 3.

Furthermore, all of the portions according to only one of the embodiments can be properly utilized mutually with the other embodiments.

The present invention having been described with reference to the foregoing embodiments should not be limited to the disclosed embodiments and modifications, but may be implemented in many ways without departing from the spirit of the invention.

What is claimed is:

1. A solid oxide fuel cell power generator comprising:
a plurality of solid oxide fuel cells, each including at least a solid electrolytic substrate, a cathode electrode layer formed on one surface of the solid electrolytic substrate, and an anode electrode layer formed on the other surface thereof, and
an insulator accommodating said plurality of solid oxide fuel cells, wherein
each of said plurality of solid oxide fuel cells is interposed between a first electric conductor having gas permeability and disposed in contact with the cathode electrode layer and a second electric conductor having gas permeability and disposed in contact with the anode electrode layer, further wherein
the first electric conductor and the second electric conductor are assembled with an insulator being interposed in-between, and the first electric conductor and the second electric conductor are functioning as collectors.

2. The solid oxide fuel cell power generator according to claim 1, wherein a third electric conductor having gas permeability is disposed between the first electric conductor and the cathode electrode layer or between the second electric conductor and the anode electrode layer.

3. The solid oxide fuel cell power generator according to claim 1, wherein the first electric conductor and the second electric conductor are formed by a metallic mesh or a porous body.

4. The solid oxide fuel cell power generator according to claim 2, wherein the first electric conductor, the second electric conductor and the third electric conductor are formed by a metallic mesh or a porous body.

5. The solid oxide fuel cell power generator according to claim 3, wherein the metallic mesh or the porous body which is disposed on the anode electrode layer side of the solid oxide fuel cell is formed of nickel or a nickel alloy.

6. The solid oxide fuel cell power generator according to claim 4, wherein the metallic mesh or the porous body which is disposed on the anode electrode layer side of the solid oxide fuel cell is formed of nickel or a nickel alloy.

7. The solid oxide fuel cell power generator according to claim 1, wherein the insulator has a plurality of hole portions in a grid array shape, each being formed to accommodate the solid oxide fuel cell thereinto, and the first electric conductor and the second electric conductor cover a whole surface of the insulator.

8. The solid oxide fuel cell power generator according to claim 7, wherein a thickness of the insulator is smaller than that of the solid oxide fuel cell.

9. The solid oxide fuel cell power generator according to claim 7, wherein the insulator is formed by an inorganic oxide sintered body, an inorganic oxide sheet having a flexibility or a metal plate having a surface covered with inorganic oxide.

10. The solid oxide fuel cell power generator according to any of claim 7, wherein the first electric conductor and the second electric conductor are assembled together with the insulator by conductive harness means that is provided in the insulator, in which the harness means and one of the first electric conductor and the second electric conductor are electrically insulated from each other.

11. The solid oxide fuel cell power generator system according to claim 1, wherein a plurality of fuel cell units, each being comprised of the cell generator as defined in claim 1, are electrically connected in series.
